(19) United States
(12) Patent Application Publication
(10) Pub. No.: US 2016/0026378 A1
(43) Pub. Date: Jan. 28, 2016

(54) Answer Confidence Output Mechanism for Question and Answer Systems

(71) Applicant: International Business Machines Corporation, Armonk, NY (US)

(72) Inventors: Scott H. Isensee, Austin, TX (US); William G. O'Keeffe, Tewksbury, MA (US); David R. Schwartz, Bellevue, WA (US); Cale R. Vardy, East York (CA)

(21) Appl. No.: 14/865,008

(22) Filed: Sep. 25, 2015

Related U.S. Application Data
(63) Continuation of application No. 14/204,068, filed on Mar. 11, 2014.

(51) Int. Cl. G06F 3/0484; G06F 17/30

(52) U.S. Cl. CPC G06F 3/04847; G06F 3/04842; G06F 17/30864; G06F 17/3053; G06F 17/30601

(57) ABSTRACT

Mechanisms are provided for generating an output of confidence score for candidate answers of an input question. The mechanisms, implemented in a data processing system configured to answer an input question receive candidate answer information comprising confidence scores associated with candidate answers for the input question. The mechanisms categorize, for each candidate answer in the candidate answer information, the corresponding confidence score into one of a plurality of confidence score categories. For each candidate answer in the candidate answer information, a graphical representation of the confidence score category of the candidate answer is generated. A graphical user interface output comprising an entry for each candidate answer in the candidate answer information is generated where each entry comprises the corresponding graphical representation of the confidence score category of the candidate answer corresponding to the entry.

### BACKGROUND

The present application relates generally to an improved data processing apparatus and method and more specifically to mechanisms for providing an answer confidence output for a question and answer (QA) system.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

One such QA system is the IBM Watson™ system available from International Business Machines (IBM) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

Various United States Patent Application Publications describe various types of question and answer systems. U.S. Patent Application Publication No. 2011/0125734 discloses a mechanism for generating question and answer pairs based on a corpus of data. The system starts with a set of questions and then analyzes the set of content to extract answer to those questions. U.S. Patent Application Publication No. 2011/0066587 discloses a mechanism for converting a report of analyzed information into a collection of questions and determining whether answers for the collection of questions are answered or refuted from the information set. The results data are incorporated into an updated information model.

### SUMMARY

In one illustrative embodiment, a method, in a data processing system comprising a processor and a memory, and being configured to answer an input question, is provided. The method comprises receiving, by the data processing system, candidate answer information comprising confidence scores associated with candidate answers for the input question. The method further comprises categorizing, by the data processing system, for each candidate answer in the candidate answer information, the corresponding confidence score into one of a plurality of confidence score categories. The method also comprises generating, by the data processing system, for each candidate answer in the candidate answer information, a graphical representation of the confidence score category of the candidate answer. In addition, the method comprises generating, by the data processing system, a graphical user interface output comprising an entry for each candidate answer in the candidate answer information. Each entry comprises the corresponding graphical representation of the confidence score category of the candidate answer corresponding to the entry.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments may be implemented;

FIG. 3 illustrates a QA system pipeline for processing an input question in accordance with one illustrative embodiment;

FIG. 4 is an example diagram of a graphical user interface in which confidence score categorizations are depicted in accordance with one illustrative embodiment;

FIG. 5 is an example diagram of a summary level graphical user interface (GUI) that may be generated in response to a drill down GUI element being selected in accordance with one illustrative embodiment;

FIG. 6 is an example diagram of a lower level evidence passage GUI in which source level information is presented for evidence passages that support, or are “for”, a candidate answer being a correct answer for an input question in accordance with one illustrative embodiment;

FIG. 7 is an example diagram of an evidence passage level GUI 700 in which individual evidence passages may be presented that are in support of, or are “for”, a candidate answer being a correct answer for an input question in accordance with one illustrative embodiment;

FIG. 8 is an example diagram of a candidate answer level GUI in which user feedback GUI elements are provided for use by a user to provide feedback as to the perceived correctness of the candidate answer's confidence ranking in accordance with one illustrative embodiment; and

FIG. 9 is a flowchart outlining an example operation for generating a GUI output of candidate answers and corresponding confidence score information in accordance with one illustrative embodiment.

### DETAILED DESCRIPTION

The illustrative embodiments provide mechanisms for providing for providing an answer confidence output for a question and answer (QA) system. A “mechanism,” as used herein, may be an implementation of the functions or aspects of the illustrative embodiments in the form of an apparatus, a procedure, or a computer program product. The mechanisms described herein may be implemented as specialized hardware, software executing on general purpose hardware, software instructions stored on a medium such that the instructions are readily executable by specialized or general purpose hardware, a procedure or method for executing the functions, or a combination of the above.

The mechanisms of the illustrative embodiments provide a visual output for displaying a graphical representation of confidence in candidate answers generated by a QA system, such as the IBM Watson™ QA system, available from International Business Machines (IBM) Corporation of Armonk, N.Y. With the mechanisms of the illustrative embodiments, calculated confidence score values are used along with defined ranges of confidence score values to categorize the confidence store into one of the plurality of confidence ranges. Based on the confidence range the confidence score falls into, a corresponding graphical representation of the level of confidence associated with the candidate answer is generated in a graphical user interface. In one illustrative embodiment, this graphical representation of the level of confidence comprises a segmented bar graph in which the number of segments of the bar graph displayed corresponds to the particular confidence score or confidence range in which the confidence score is categorized. In addition, or alternatively, the color, or colors, of the segments of the bar graph may be selected according the confidence score or confidence range in which the confidence score is categorized. For example, if a confidence score falls within a defined range of confidence scores corresponding to a “high” confidence, then the number of segments of the bar graph that are displayed may be a maximum number of segments, e.g., 5 segments, with the color of the graph being set to green color. If the confidence score falls within a defined range of confidence scores corresponding to a “low” confidence, then the number of segments of the bar graph that are displayed may be a minimum number of segments, e.g., 1 segment, with the color of the graph being set to a red color. Alternatively, the number of segments displayed may be constant with only the colors being different based on the confidence score and/or categorization of the confidence score with regard to the defined confidence ranges. Moreover, in some illustrative embodiments the colors may be graduated across the segments of the bar graph with colors at one end of the segmented bar graph being indicative of a low confidence categorization and colors at an opposite end of the segmented bar graph being indicative of a high confidence categorization.

In some illustrative embodiments, the number of segments of the bar graph may be representative of the confidence range in which the confidence score is categorized whereas the color of the segments of the bar graph may be representative of where, within the confidence range, the particular confidence score of the candidate answer falls. That is, for example, if a confidence score falls within a confidence range corresponding to a “high” confidence, then the number of segments is set equal to the maximum number of segments, e.g., 5, and the corresponding color for the output of the segments is generally in the green hue. However, if the actual confidence score falls closer to the lower end of the confidence score range, the particular shade of green color may be set to a different shade of green than if the confidence score fell within the confidence range closer to the upper end of the confidence range. Thus, both the number of segments of the bar graph and the particular shade of coloring of the segments may be used as a visual indicator as to how much confidence there is in the corresponding candidate answer.

In addition to the above illustrative embodiments, the graphical representation of the confidence score may be associated with a textual description indicative of the particular confidence range in which the confidence score is categorized, or “falls”. For example, if the confidence score for the candidate answer is categorized into a confidence range of “high,” then a textual label of “high” or the like may be output along with the graphical representation of the confidence score in close proximity to the graphical representation of the confidence score. Moreover, the numerical confidence score value itself may also be displayed in association with the graphical representation of the confidence score and/or the textual label. In this way, both a graphical representation of the categorization of the confidence score and a textual output indicating the categorization are made possible to aid the viewer in discerning the confidence associated with a candidate answer.

Graphical and/or textual representations of candidate scores and/or their categorization may be generated and output via a graphical user interface for a plurality of candidate answers. The organization of the various graphical and/or textual representations of candidate scores/categorizations may take many different formats including, but not limited to, a format in which candidate answers are organized by descending/ascending candidate scores, descending/ascending candidate score categorizations, and the like. Graphical user interface elements, selectable by a user, and logic may be provided for modifying the organization according to a user's desires, e.g., changing from descending to ascending or vice versa.

The graphical user interface outputting the graphical and/or textual representations of the candidate scores and/or their categorizations may further comprise, for each candidate answer, a graphical user interface element that is selectable by a user to drill down into evidence in support of the calculation of the candidate answer's confidence score. This evidence may be evidence that is in support of, or is in favor of, the candidate answer being a correct answer for an input question and evidence that is not in support of, or otherwise detracts from of is not in favor of, the candidate answer being a correct answer for the input question. The drilling down functionality may have multiple levels of drill down graphical user interfaces available including a summary level and levels in which individual pieces of evidence may be individually investigated, such as a document level, a passage level, or the like.

The summary level graphical user interface that is generated in response to the drill down graphical user interface (GUI) element being selected may organize the evidence into evidence “for” and “against” the candidate answer being a correct answer for the input question, thereby allowing a user to further drill down into evidence that is either “for” or “against” the candidate answer. The classification of evidence “for” or “against” the candidate answer may be based on corresponding evidence scores and the comparison of such evidence scores against one or more threshold values indicative of whether the evidence is “for” or “against” the candidate answer being an actual correct answer for the input question.

Drilling down further into the evidence may produce a listing of document or source level information for one or more documents/sources of information that are classified in the particular “for” or “against” classification. The document or source information may, for each document or source, identify the particular document, publication, authorship, evidence score, a summary or description of the document or source, and/or other information about the piece of evidence. The entry for the document or source may be further selectable by a user within the GUI so as to obtain a more detailed level of information about the particular portions of the document or source that provide the evidence “for” or “against” the candidate answer, such as passages from the document or source, titles, factual statements, or other content of the document or source evaluated for evidence in support of or against the candidate answer.

At any or all of the various levels of the graphical user interface, entries for the candidate answers and/or evidence may be associated with a feedback GUI element through which a user may provide feedback as to the correctness of the corresponding entry with regard to the confidence value associated with the candidate answer. For example, at the highest level of the GUI, the user feedback is indicative of whether the confidence value categorization and the candidate answer as a whole is correctly evaluated. That is, if the user finds that the candidate answer is correctly categorized as having a high confidence of being a correct answer for the input question, the user may specify a relatively high user feedback value indicating that the result generated by the QA system is correct. Similarly, if the user finds that the candidate answer is not correctly categorized as having a high confidence of being a correct answer, then the user can so indicate by providing a relatively low user feedback value. This can be done for all confidence/evidence scores indicating the correctness or inaccuracy of the corresponding confidence/evidence score. Thus, even low confidence/evidence scores may receive user feedback indicating whether or not the low confidence/evidence score is accurate for the particular candidate answer or piece of evidence. The user feedback may be provided as input to the QA system which may then adjust weightings or other logic applied to the evaluation of candidate answers and evidence so as to adjust the operation of the QA system to be more accurate based on the user feedback.

It should be appreciated that rather than using a segmented bar graph representation for the confidence values and categorization of confidence values into confidence ranges, other types of graphical representations may likewise be used. For example, segmented pie chart type representations, various icons for different levels of confidence, and the like, may be used to provide a visual and/or textual output indicative of confidence score values and/or confidence score categorization without departing from the spirit and scope of the illustrative embodiments.

Moreover, the representation of confidence score values and/or confidence score categorization may take non-visual forms including using pitch and cadence of voice from a speech output system to convey confidence score values and/or confidence score categorization. This may be done in much the way that a human being who is confident about a particular statement has a pitch and cadence that sounds confident. Moreover, the terms “confident,” “certain,” or other words of confidence level and category may be used in the audio output of the candidate answers themselves to thereby identify the confidence score value and/or confidence score categorization. For example, phrases such as “I am certain that the answer is . . . ”, “The answer is probably . . . ”, “I think it may be . . . ”, or “I am guessing that the answer is . . . ” all convey different levels of confidence and categorizations of confidence and may be used to output in an audio manner the representation of the confidence score value and/or its categorization. Of course a combination of audio and visual outputs may be used without departing from the spirit and scope of the illustrative embodiments.

Thus, the illustrative embodiments provide mechanisms for providing a graphical representation of confidence scores for candidate answers in a QA system output. The GUI presenting the graphical representation further provides GUI elements for drilling down into the evidence that supports/detracts from the candidate answer being a correct answer for the input question. Various levels of drilling down are supported by the GUI to allow a user to access various levels of evidence information to gain greater insight into the reasoning behind the candidate answer's corresponding confidence score valuation and categorization.

As will be appreciated by those of ordinary skill in the art, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

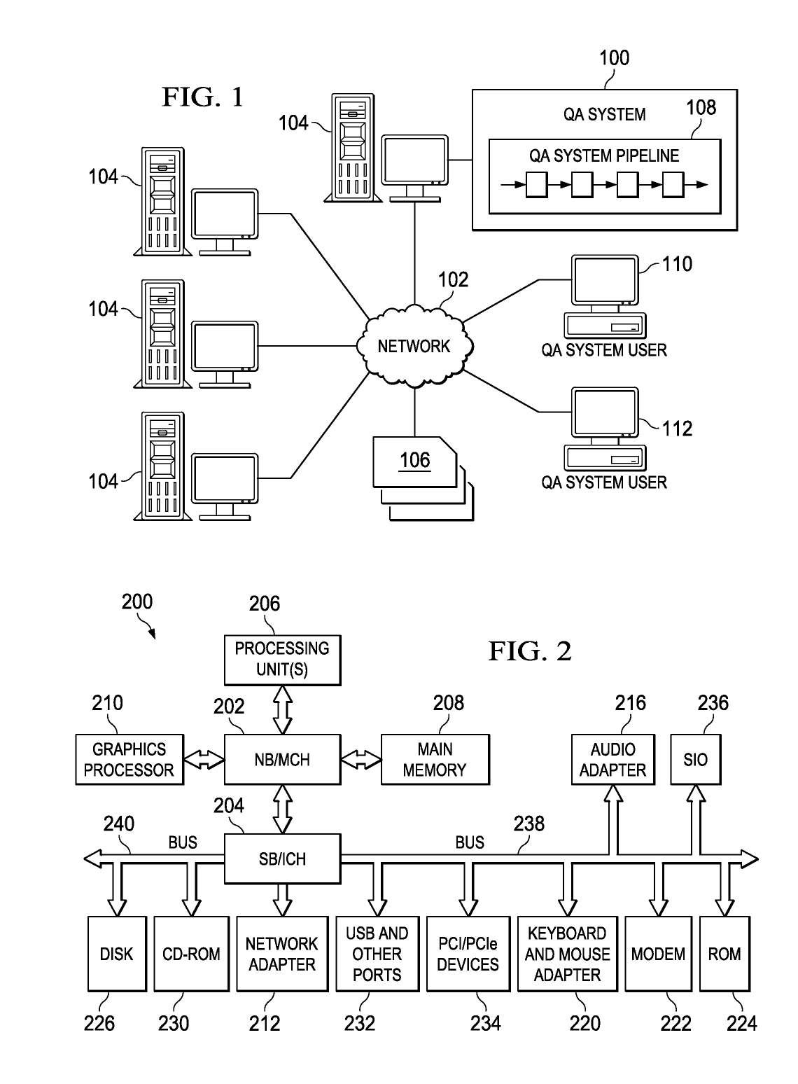

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example Question/Answer, Question and Answer, or Question Answering system, methodology, and computer program product (referred to herein as a “QA” system, methodology or computer program product), with which the mechanisms of the illustrative embodiments may be implemented. As will be discussed in greater detail hereafter, the illustrative embodiments may be integrated in, and may augment and extend the functionality of, these QA mechanisms with regard to the presentation of candidate answers and their corresponding confidence score values so as to facilitate greater understanding of the relative confidence in the candidate answers and the reasoning behind the generated confidence score values associated with the candidate answers.

Thus, it is important to first have an understanding of how question and answer creation in a QA system may be implemented before describing how the mechanisms of the illustrative embodiments are integrated in and augment such QA systems. It should be appreciated that the QA mechanisms described in FIGS. 1-3 are only examples and are not intended to state or imply any limitation with regard to the type of QA mechanisms with which the illustrative embodiments may be implemented. Many modifications to the example QA system shown in FIGS. 1-3 may be implemented in various embodiments of the present invention without departing from the spirit and scope of the present invention.

QA mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, may determine use cases for products, solutions, and services described in such content before writing their content. Consequently, the content creators may know what questions the content is intended to answer in a particular topic addressed by the content. Categorizing the questions, such as in terms of roles, type of information, tasks, or the like, associated with the question, in each document of a corpus of data may allow the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, may annotate or otherwise generate metadata for providing information useable by the QA system to identify these question and answer attributes of the content.

Operating on such content, the QA system generates answers for input questions using a plurality of intensive analysis mechanisms which evaluate the content to identify the most probable answers, i.e. candidate answers, for the input question. The illustrative embodiments leverage the work already done by the QA system to reduce the computation time and resource cost for subsequent processing of questions that are similar to questions already processed by the QA system.

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. The QA system 100 may be implemented on one or more computing devices 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. The QA system 100 and network 102 may enable question/answer (QA) generation functionality for one or more QA system users via their respective computing devices 110-112. Other embodiments of the QA system 100 may be used with components, systems, sub-systems, and/or devices other than those that are depicted herein.

The QA system 100 may be configured to implement a QA system pipeline 108 that receive inputs from various sources. For example, the QA system 100 may receive input from the network 102, a corpus of electronic documents 106, QA system users, or other data and other possible sources of input. In one embodiment, some or all of the inputs to the QA system 100 may be routed through the network 102. The various computing devices 104 on the network 102 may include access points for content creators and QA system users. Some of the computing devices 104 may include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 may include local network connections and remote connections in various embodiments, such that the QA system 100 may operate in environments of any size, including local and global, e.g., the Internet.

In one embodiment, the content creator creates content in a document of the corpus of data 106 for use as part of a corpus of data with the QA system 100. The document may include any file, text, article, or source of data for use in the QA system 100. QA system users may access the QA system 100 via a network connection or an Internet connection to the network 102, and may input questions to the QA system 100 that may be answered by the content in the corpus of data 106. In one embodiment, the questions may be formed using natural language. The QA system 100 may interpret the question and provide a response to the QA system user, e.g., QA system user 110, containing one or more answers to the question. In some embodiments, the QA system 100 may provide a response to users in a ranked list of candidate answers.

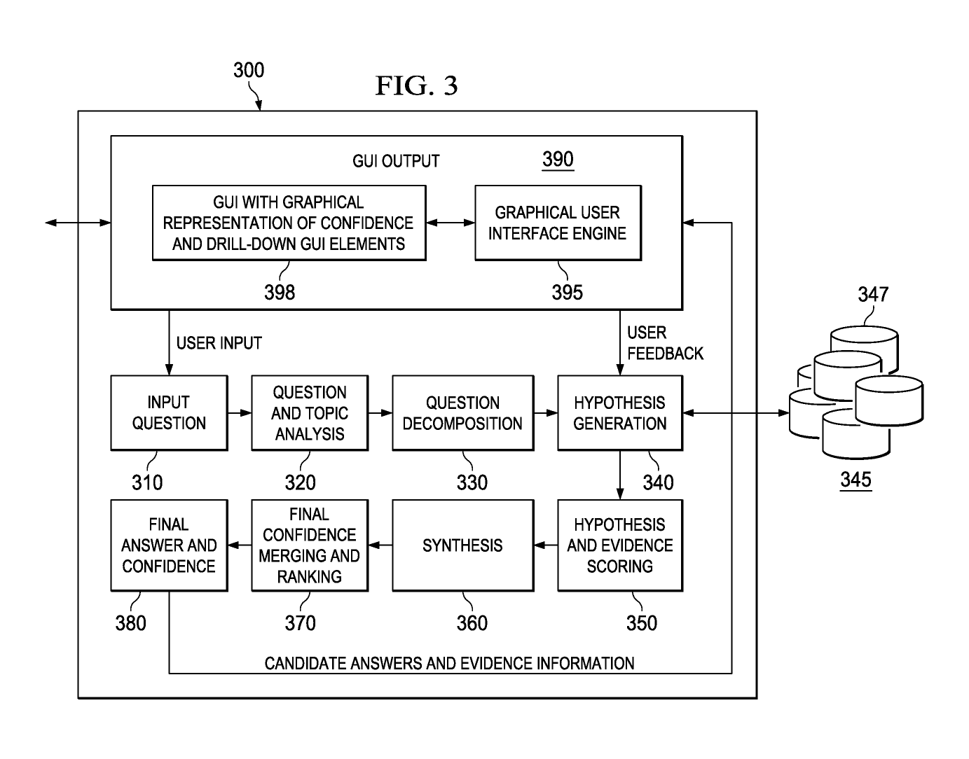

The QA system 100 implements a QA system pipeline 108 which comprises a plurality of stages for processing an input question, the corpus of data 106, and generating answers for the input question based on the processing of the corpus of data 106. The QA system pipeline 108 will be described in greater detail hereafter with regard to FIG. 3.

In some illustrative embodiments, the QA system 100 may be the IBM Watson™ QA system available from International Business Machines Corporation of Armonk, N.Y., which is augmented with the mechanisms of the illustrative embodiments described hereafter. The IBM Watson™ QA system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

FIG. 2 is a block diagram of an example data processing system in which aspects of the illustrative embodiments may be implemented. Data processing system 200 is an example of a computer, such as server 104 or client 110 in FIG. 1, in which computer usable code or instructions implementing the processes for illustrative embodiments of the present invention may be located. In one illustrative embodiment, FIG. 2 represents a server computing device, such as a server 104, which, which implements a QA system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System P® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 may be implemented as one or more software engines, components, or the like, which are configured with logic for implementing the functionality attributed to the particular stage. Each stage may be implemented using one or more of such software engines, components or the like. The software engines, components, etc. may be executed on one or more processors of one or more data processing systems or devices and may utilize or operate on data stored in one or more data storage devices, memories, or the like, on one or more of the data processing systems. The QA system pipeline of FIG. 3 may be augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user may input, via a user interface, an input question for which the user wishes to obtain an answer, e.g., “Who are Washington's closest advisors?” In response to receiving the input question, the next stage of the QA system pipeline 500, i.e. the question and topic analysis stage 320, parses the input question using natural language processing (NLP) techniques to extract major features from the input question, classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

The identified major features may then be used during the question decomposition stage 330 to decompose the question into one or more queries that may be applied to the corpora of data/information 345 in order to generate one or more hypotheses. The queries may be generated in any known or later developed query language, such as the Structure Query Language (SQL), or the like. The queries may be applied to one or more databases storing information about the electronic texts, documents, articles, websites, and the like, that make up the corpora of data/information 345. That is, these various sources themselves, different collections of sources, and the like, may represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries may be applied to one or more databases storing information about the electronic texts, documents, articles, websites, and the like, that make up the corpus of data/information, e.g., the corpus of data 106 in FIG. 1. The queries being applied to the corpus of data/information at the hypothesis generation stage 340 to generate results identifying potential hypotheses for answering the input question which can be evaluated. That is, the application of the queries results in the extraction of portions of the corpus of data/information matching the criteria of the particular query. These portions of the corpus may then be analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer” as well as performs evidence scoring to evaluate the likelihood that the particular hypothesis is a correct answer for the input question. As mentioned above, this may involve using a plurality of reasoning algorithms, each performing a separate type of analysis of the language of the input question and/or content of the corpus that provides evidence in support of, or not, of the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis.

In the synthesis stage 360, the large number of relevance scores generated by the various reasoning algorithms may be synthesized into confidence scores for the various hypotheses. This process may involve applying weights to the various scores, where the weights have been determined through training of the statistical model employed by the QA system and/or dynamically updated, as described hereafter. The weighted scores may be processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which may compare the confidence scores and measures, compare them against predetermined thresholds, or perform any other analysis on the confidence scores to determine which hypotheses/candidate answers are the most likely to be the answer to the input question. The hypotheses/candidate answers may be ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, may be generated and output to the submitter of the original input question.

As shown in FIG. 3, in accordance the illustrative embodiments, after stage 380, or as part of stage 380, the set of candidate answers is output via a graphical user interface generated using the mechanisms of the illustrative embodiment, which provide the user with a graphical representation of the confidence scores associated with a plurality of candidate answers as well as graphical user interface (GUI) elements for drilling down into the evidence associated with the candidate scores. That is, as shown in FIG. 3, at stage 390, the graphical user interface engine 395 of the illustrative embodiments not only receives the final ranked listing of candidate answers generated by the QA system pipeline 300, but also receives the underlying evidence information for each of the candidate answers from the hypothesis and evidence scoring stage 350, and uses this information to generate a graphical user interface 398 outputting the ranked listing of candidate answers with graphical representations of confidence score, categorization of confidence score, or the like, and one or more GUI elements for outputting various levels of evidence associated with the candidate answer and confidence score/categorization including a summary level of evidence information, document/source level of evidence information, and/or an individual evidence piece level of evidence information that may identify the selected portions of the corpus of data/information that supports, and/or detracts, from the candidate answers being the correct answer for the input question, referred to hereafter as the “evidence passages.”

For example, the graphical user interface engine 395 may be implemented as an Application Programming Interface (API) layer provided between the QA system pipeline 300 and the graphical user interface 398 through which the user provides input and receives outputs. The graphical user interface 398 may be utilized to receive the original input question and may be used to output the results of the QA system pipeline 300 processing of the input question. Moreover, the graphical user interface 398 may be used to receive additional inputs into the graphical user interface 398 for requesting further detailed information about the reasoning and supporting evidence for the results of the QA system pipeline 300 processing of the input question. The graphical user interface 398 communicates with the QA system pipeline 300 via the graphical user interface engine 395 or API layer.

Each candidate answer that is returned by the QA system pipeline has an associated confidence score, supporting evidence, and other information regarding the candidate answer. In one illustrative embodiment, this information may be returned as a JavaScript Object Notation (JSON) binary object, or “blob.” For example, this information may be returned in a data structure of the following type:

{

“question”: {

“questionText”: “A Question”,
“answers”: [
{

“id”: 0,
“text”: “An Answer”,
“confidence”: 0.67598
“evidence”: [{ }]

},
{

“id”: 1,
“text”: “Another Answer”,
“confidence”: 0.6376,
“evidence”: [{ }]

}

}

}

The graphical user interface engine 395 may utilize the confidence score values along with defined ranges of confidence score values to categorize the confidence score into one of the plurality of confidence ranges. For example, for a given candidate answer, the confidence score associated with the candidate answer may be converted to a percentage value, e.g., 0.67598 is converted to 67.598%, and that percentage value is then compared against one or more thresholds to thereby categorize the confidence score into one of a plurality of confidence ranges based on the specific implementation. For example, various percentage ranges may be established for “High”, “Medium”, and “Low” confidence score ranges. Based on which range of percentages the specific percentage for the candidate answer falls into, the corresponding confidence range categorization is associated with the candidate answer, e.g., “High”, “Medium”, or “Low.” It should be appreciated that while this example utilizes percentage values, any value that is generated based on the confidence score, or even the confidence score itself, may be used to categorize the confidence score into a corresponding range of confidence score values without departing from the spirit and scope of the illustrative embodiments.

Based on the confidence range the confidence score falls into, a corresponding graphical representation of the level of confidence associated with the candidate answer is generated in the graphical user interface 398. In one illustrative embodiment, this graphical representation of the level of confidence comprises a segmented bar graph in which the number of segments of the bar graph displayed corresponds to the particular confidence score or confidence range in which the confidence score is categorized. In addition, or alternatively, the color, or colors, of the segments of the bar graph may be selected according the confidence score or confidence range in which the confidence score is categorized. Alternatively, the number of segments displayed may be constant with only the colors being different based on the confidence score and/or categorization of the confidence score with regard to the defined confidence ranges. Moreover, in some illustrative embodiments the colors may be graduated across the segments of the bar graph with colors at one end of the segmented bar graph being indicative of a low confidence categorization and colors at an opposite end of the segmented bar graph being indicative of a high confidence categorization. In some illustrative embodiments, the number of segments of the bar graph may be representative of the confidence range in which the confidence score is categorized whereas the color of the segments of the bar graph may be representative of where, within the confidence range, the particular confidence score of the candidate answer falls. Thus, both the number of segments of the bar graph and the particular shade of coloring of the segments may be used as a visual indicator as to how much confidence there is in the corresponding candidate answer.

In addition to the above illustrative embodiments, the graphical representation of the confidence score may be associated with a textual description indicative of the particular confidence range in which the confidence score is categorized. For example, if a candidate answer's confidence score is categorized in the “High” range of confidence scores, then the textual description of “High” may be associated with the graphical representation of the confidence score, e.g., the segmented bar graph. The textual description may be positioned relative to the graphical representation of the confidence score in any of a number of arrangements or orientations. For example, the textual description may be provided above, below, to the left, or to the right of the graphical representation of the confidence score. Moreover, the numerical confidence score value itself may also be displayed in association with the graphical representation of the confidence score and/or the textual label, again in any suitable arrangement or orientation. In this way, both a graphical representation of the categorization of the confidence score and a textual output indicating the categorization are made possible to aid the viewer in discerning the confidence associated with a candidate answer.

Graphical and/or textual representations of candidate scores and/or their categorization may be generated by the graphical user interface engine 395 and output as the graphical user interface 398 for a plurality of candidate answers. The organization of the various graphical and/or textual representations of candidate scores/categorizations may take many different formats including, but not limited to, a format in which candidate answers are organized by descending/ascending candidate scores, descending/ascending candidate score categorizations, and the like. Graphical user interface elements, selectable by a user, and logic may be provided for modifying the organization according to a user's desires, e.g., changing from descending to ascending or vice versa.

The graphical user interface 398 through which the graphical and/or textual representations of the candidate scores and/or their categorizations are output may further comprise, for each candidate answer, a graphical user interface element that is selectable by a user to drill down into evidence passages in support of the calculation of the candidate answer's confidence score. These evidence passages may be evidence passages that are in support of, or are in favor of, the candidate answer being a correct answer for an input question and evidence passages that are not in support of, or otherwise detract from or is not in favor of, the candidate answer being a correct answer for the input question. The drilling down functionality may have multiple levels of drill down graphical user interfaces available including a summary level and levels in which individual evidence passages may be individually investigated, such as a document level, a passage level, or the like.

The summary level graphical user interface that is generated in response to the drill down graphical user interface (GUI) element being selected may organize the evidence passages into evidence passages “for” and “against” the candidate answer being a correct answer for the input question, thereby allowing a user to further drill down into evidence passages that are either “for” or “against” the candidate answer. The classification of evidence passages “for” or “against” the candidate answer may be performed by the graphical user interface engine 395 based on corresponding evidence scores and the comparison of such evidence scores against one or more threshold values indicative of whether the evidence is “for” or “against” the candidate answer being an actual correct answer for the input question.

For example, if an evidence score for an evidence passage is greater than 0.75, then the evidence passage may be determined to be in favor of the candidate answer being a correct answer. If the evidence score for an evidence passage is less than 0.50, then the evidence passage may be determined to be against the candidate answer being a correct answer. If the evidence score lies between these two thresholds, then the evidence passage may be considered neither in favor of or against the candidate answer and may be further categorized into neutral evidence passages. Alternatively, a single threshold may be established with evidence scores above that threshold being considered to be associated with evidence passages “for” the candidate answer and evidence scores below the threshold being associated with evidence passages “against” the candidate answer. Any mechanism, organization of thresholds values, and logic may be used to classify evidence passages as “for” or “against” the candidate answer may be used without departing from the spirit and scope of the illustrative embodiments.

Drilling down further into the evidence passages may produce a listing of document or source level information for one or more documents/sources of information that are classified in the particular “for” or “against” classification. The document or source information may, for each document or source, identify the particular document, publication, authorship, evidence score, a summary or description of the document or source, and/or other information about the piece of evidence. The entry for the document or source may be further selectable by a user within the GUI so as to obtain a more detailed level of information about the particular portions of the document or source that provide the evidence “for” or “against” the candidate answer, such as passages from the document or source, titles, factual statements, or other content of the document or source evaluated for evidence in support of or against the candidate answer.

At any or all of the various levels of the graphical user interface, entries for the candidate answers and/or evidence may be associated with a feedback GUI element through which a user may provide feedback as to the correctness of the corresponding entry with regard to the confidence value associated with the candidate answer. The user feedback may be provided by the graphical user interface engine 395 as input back to the QA system pipeline 300 which may then adjust weightings or other logic applied to the evaluation of candidate answers and evidence at various stages of the QA system pipeline 300 so as to adjust the operation of the QA system pipeline to be more accurate based on the user feedback.

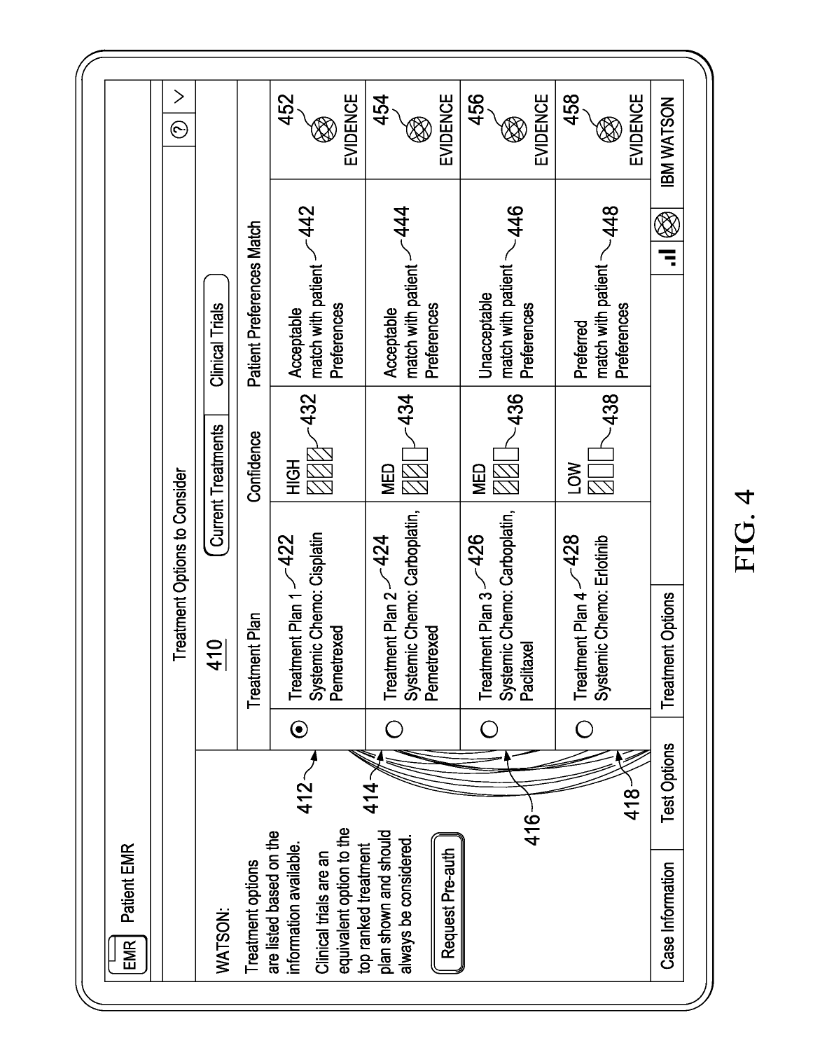

FIG. 4 is an example diagram of a graphical user interface in which confidence score categorizations are depicted in accordance with one illustrative embodiment. The graphical user interface 400 in FIG. 4 may be a graphical user interface 398 as generated by a graphical user interface engine 395 or APIs based on candidate answer results generated by a corresponding QA system pipeline 300, for example. In the depicted example, the candidate answer results are various treatment plans for an input question requesting treatment plans for a specific type of medical condition. This is only an example and is not intended to state or imply any limitation as to the arrangement, configuration, or content of a graphical user interface generated using the mechanisms of the illustrative embodiments.

As shown in FIG. 4, the graphical user interface comprises a table 410 comprising a plurality of entries 412-418 for various candidate answers, which in this case are various treatment plans for a question asking for treatment plans for a particular medical condition. Each entry 412-418 in the table 410 comprises a first element 422-428 describing the candidate answer, e.g., “Treatment plan 1—Systematic Chemo: Cisplatin, Pemetrexed”, a second element 432-438 comprising a graphical/textual representation of confidence score for the corresponding candidate answer, e.g., a segmented bar graph with textual label, a third element 442-448 indicating a level of matching of the candidate answer with user (in this case patient) preferences, and a fourth element 452-458 comprising a graphical user interface element that is selectable by the user for drilling down into the evidence passage information for the corresponding candidate answer. As shown, the entries 412-418 are organized in descending order of confidence.

As shown in the second element 432-438 the graphical representation of the confidence score comprises a segmented bar graph which, in this depicted example, has 3 segments and there are three possible categorizations of confidence scores, i.e. “High”, “Med”, or “Low”. In this example, all 3 segments are shown regardless of the particular categorization, but the coloring of the segments is modified according to the corresponding confidence score categorization. For example, as shown in FIG. 4, segments that are colored “gray” are considered to be not representative of the confidence score categorization, e.g., they are considered non-segments. These non-segments could also be removed entirely from the display such that different numbers of segments are displayed depending upon the particular categorization of confidence scores. The other segments of the segmented bar graphs are colored in accordance with the corresponding confidence score categorization. Thus, in the case of a candidate answer whose confidence score is categorized into a “High” category, the coloring of the all 3 segments is set to a first color, e.g., green. In the case of a candidate answer whose confidence score is categorized into a “Med” category, the segments (the left 2 segments in this case) are displayed with a blue coloring. Similarly, in the case of a candidate answer whose confidence score is categorized into a “Low” confidence category, the segment (the left most segment in this case) is colored with a light blue coloring.

It should be appreciated that the colorings chosen for the depicted example are only examples and other colorings may be used without departing from the spirit and scope of the illustrative embodiments. For example, in some illustrative embodiments, the colorings may be graduated across the segments such that a first (leftmost segment) may be light blue, a second segment may be blue, and a third segment may be green, or various shades of a single color may be graduated across the segments.

In addition to the graphical representation of the confidence score categorization provided by way of the segmented bar graph associated with each entry 412-418, a textual label for the confidence score categorization is also provided in this depicted example. Thus, if the confidence score categorization is in the “High” category, then the textual label of “High” is output in association with the segmented bar graph, for example. In the depicted example, this textual label is positioned above the segmented bar graph but can be positioned in any suitable position in relation to the segmented bar graph including above, below, to the left or to the right of the segmented bar graph. Moreover, although not shown in FIG. 4, in other illustrative embodiments, the numerical representation of the actual confidence score may also be output in association with the graphical representation of the confidence score categorization, either as a separate label or as part of the textual label mentioned above. Thus, for example, if the confidence score is 0.67598, then a numerical confidence score label of “67.598%” may be output in association with the segmented bar graph. Of course, this numerical confidence score label may be modified, such as truncated, normalized, or the like, to any desirable value that provides a meaningful indication of the confidence score associated with the entry 412-418.

Although not shown in the depicted example of FIG. 4, as previously mentioned above, in some illustrative embodiments, the number of segments of the bar graph may be representative of the confidence range in which the confidence score is categorized (as shown) whereas the color of the segments of the bar graph may be representative of where, within the confidence range, the particular confidence score of the candidate answer falls. For example, as shown in FIG. 4, both the entries 414 and 416 have confidence scores that are categorized in the “Med” confidence score category and thus, in the depicted example have a same coloring of the 2 left most segments of the segmented bar graph. However, in an alternative embodiment, if the confidence score for entry 414 is closer to the upper end of the “Med” range of confidence scores while the entry 416 is closer to the lower end of the “Med” range of confidence scores, then the shade of blue coloring used for the segmented bar graph of entry 414 may be relatively darker than the shade of blue used for the coloring of the segments of the segmented bar graph of entry 416, for example. Thus, different colorings can be used for different confidence score categories and different shades of these colorings may be used to provide a visual indication of where within the confidence score category a particular confidence score falls.

Thus, both the number of segments of the bar graph and the particular shade of coloring of the segments may be used as a visual indicator as to how much confidence there is in the corresponding candidate answer. Adding textual and/or numerical labels to these graphical representations of confidence scores and confidence score categories further provides a visual indication of confidence in the candidate answers generated by the QA system.

As discussed above, in addition to the graphical/textual representation of confidence scores provided in elements 432-438, GUI elements 442-448 provide an indication of a degree of matching of the corresponding candidate answer to user preferences (or patient preferences in the depicted example). Thus, for example, while a candidate answer may have a high confidence of being a correct answer to an input question, the candidate answer may not be the best match for the users' preferences. For example, if a particular treatment for a disease has high confidence of being a correct treatment for the disease, a user's preferences may specify an allergic reaction to the treatment, a user desire to not use certain types of treatments, or the like, and thus, the elements 442-448 may indicate a degree of matching of the candidate answer to the user's preferences in addition to the overall confidence in the candidate answer as provided by elements 432-438. Similarly, a candidate answer may have a relatively lower confidence score value and/or categorization but a high degree of matching with user preferences. Thus, information is provided to the user of not only the confidence score values and/or categorization but also the degree of matching of the candidate answer to user preferences.

Further, as mentioned above, the graphical user interface 398 generated by the graphical user interface engine 395 of the illustrative embodiments, may present a GUI element 452-458 in association with each entry 412-418 that is user selectable for drilling down into the evidence passages that provide the basis for the confidence score generated for the corresponding candidate answer of the entry 412-418. This evidence may be evidence that is in support of, or is in favor of, the candidate answer being a correct answer for an input question and evidence that is not in support of, or otherwise detracts from of is not in favor of, the candidate answer being a correct answer for the input question. The drilling down functionality may have multiple levels of drill down graphical user interfaces available including a summary level and levels in which individual pieces of evidence may be individually investigated, such as a document level, a passage level, or the like.

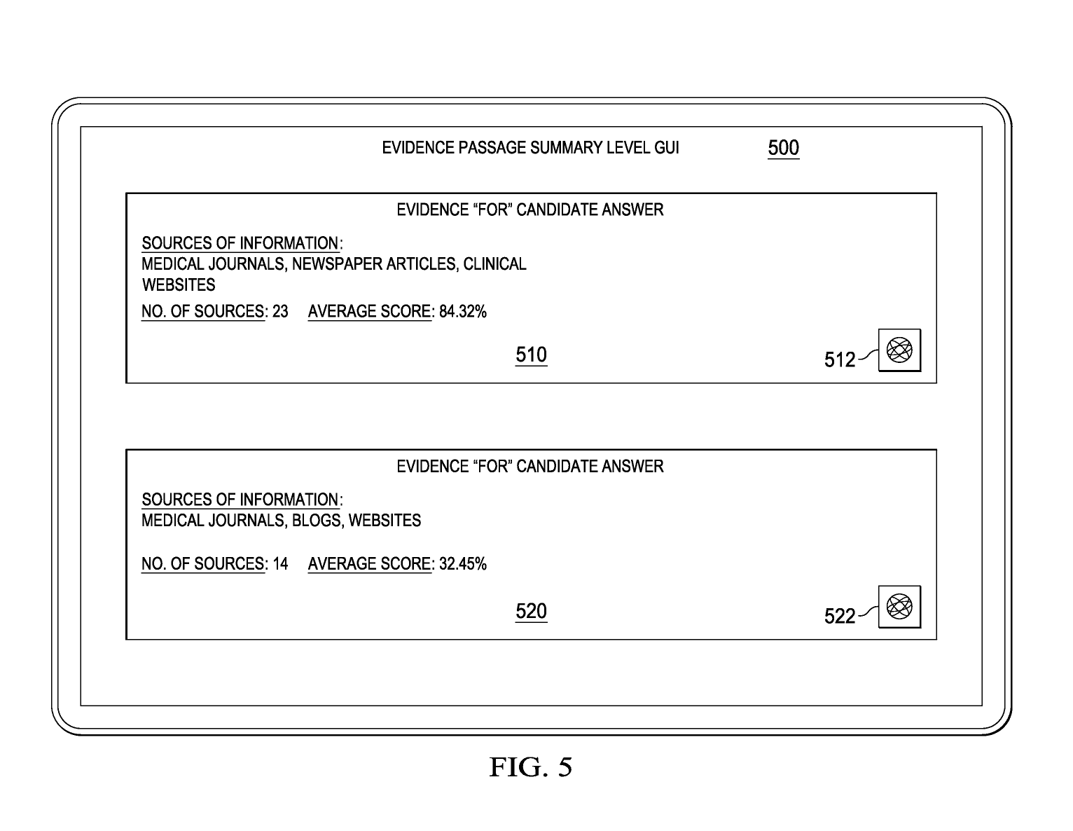

FIG. 5 is an example diagram of a summary level graphical user interface (GUI) that may be generated in response to the drill down GUI element 452-458 being selected in accordance with one illustrative embodiment. As shown in FIG. 5, the summary level GUI 500 may organize the evidence into evidence “for” 510 and “against” 520 the candidate answer being a correct answer for the input question. The portions 510 and 520 of the summary level GUI may present summary information about the evidence passages falling into the “for” or “against” category including, for example, the number of evidence passages in each of the “for” or “against” categories, an average confidence score rating for the evidence passages in the “for” or “against” categories, and the like. In some illustrative embodiments, although not shown in the diagram, an example excerpt from the evidence passages selected based on the average confidence score rating for the particular “for” or “against” category, e.g., an evidence passage having a confidence score closest to the average confidence score may be used as a basis for outputting the example excerpt, and the like.

The data used to generate the information displayed in the portions 510, 520 of the summary level GUI 500 is obtained from the results generated by the QA system pipeline which includes the evidence information evaluated by the QA system pipeline when generating the candidate answers and their corresponding confidence scores. Additional logic may be provided in the graphical user interface engine 395 for analyzing or evaluating the evidence information returned by the QA system pipeline so as to generate the summary level GUI 500. Such analysis may comprise evaluating the evidence to generate evidence scores, evaluating already generated evidence scores, or the like, and comparing them to one or more thresholds for determining whether the evidence is “for” or “against” the candidate answer being a correct answer for the input question.

Each of the portions 510 and 520 may further comprise a GUI element 512, 522 that is user selectable to further drill down into the evidence passage information for evidence passages that are either “for” or “against” the candidate answer being a correct answer to the input question. In response to a user selecting one of the elements 512, 522, the corresponding lower level evidence passage information is then displayed. The lower level evidence passage may take one of many different types of evidence passage information including source level information, individual document or evidence passage level information, or the like.

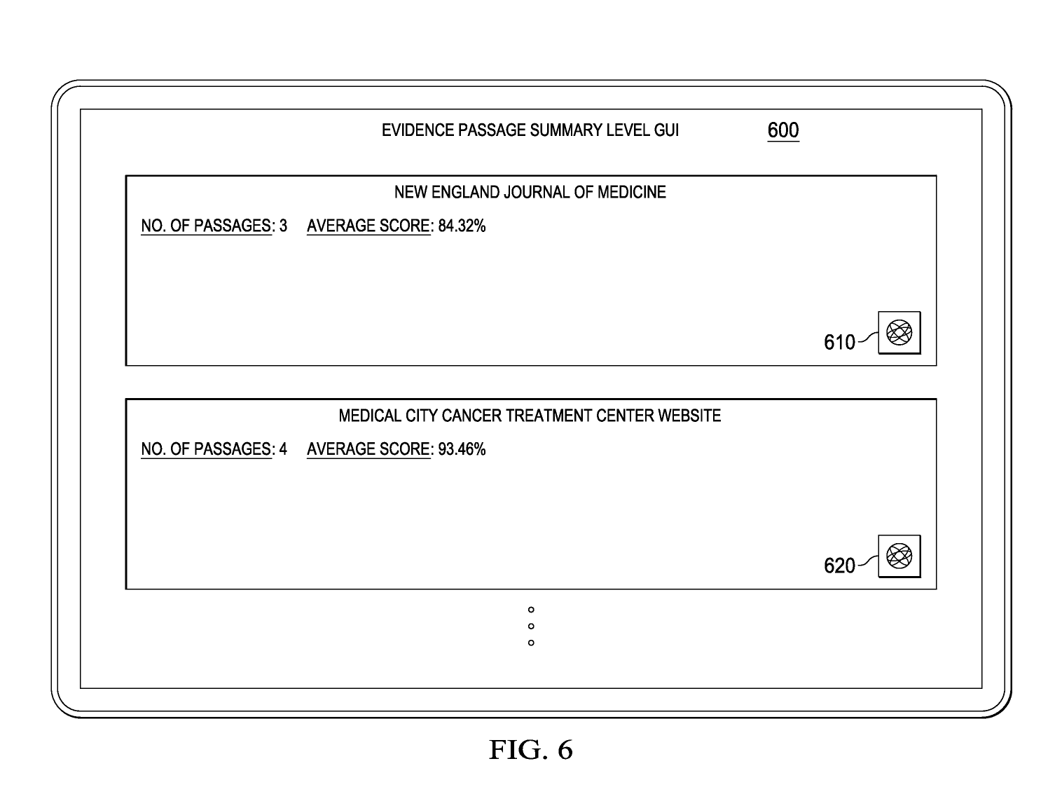

FIG. 6 is an example diagram of a lower level evidence passage GUI 600 in which source level information is presented for evidence passages that support, or are “for”, a candidate answer being a correct answer for an input question in accordance with one illustrative embodiment. The GUI 600 may be generated in response to a user selecting a GUI element 512 from a summary level GUI 500, for example. As shown in FIG. 6, the GUI 600 may list publications, websites, individual documents, or the like (collectively referred to as “sources”), that are sources of the evidence passages that were evaluated or used to generate a candidate answer and/or generate a confidence score associated with the candidate answer. The listing of sources may specify publication information for the sources, authorship information, user ratings of the source, average confidence score of the evidence passages associated with the source, a representative excerpt from the evidence passages of the source, or any other information indicative of the source, its credibility, and the like. As with the summary level GUI 500, the entries in the source level GUI 600 may have a GUI element 610, 620 that is user selectable to drill down into the evidence passages associated with a particular source.

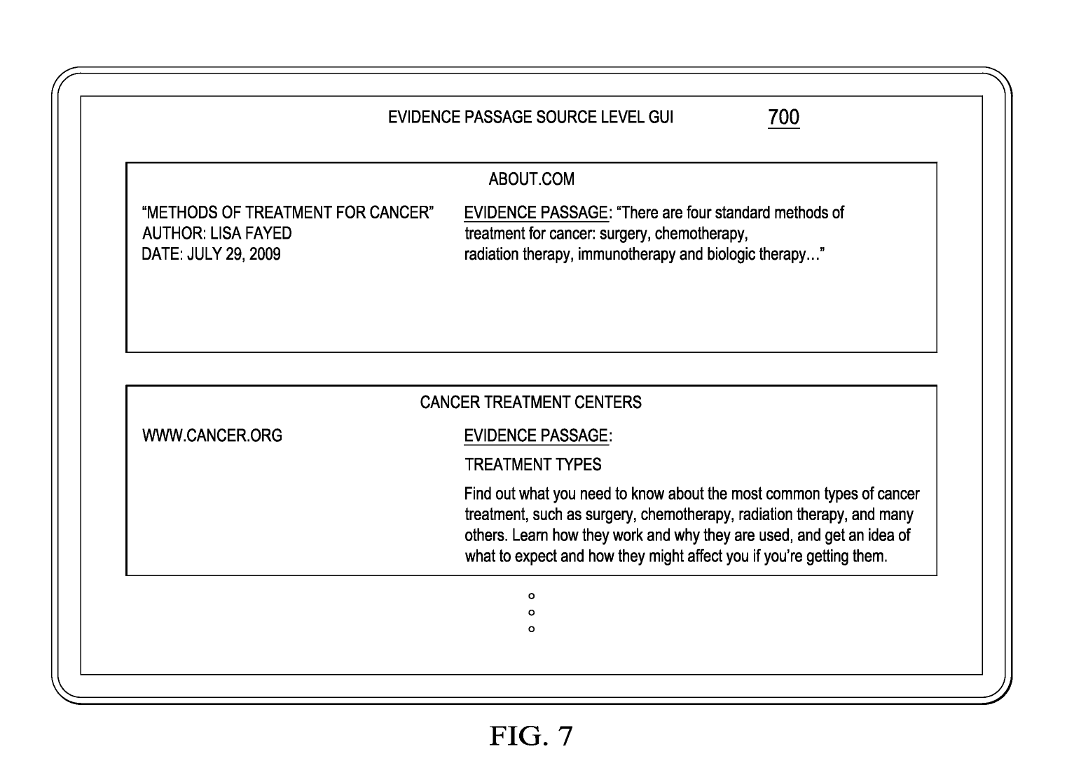

FIG. 7 is an example diagram of an evidence passage level GUI 700 in which individual evidence passages may be presented that are in support of, or are “for”, a candidate answer being a correct answer for an input question in accordance with one illustrative embodiment. The evidence passage level GUI 700 may be generated in response to a user selecting a source level GUI 600 element 610 associated with a source of evidence passages. As shown in FIG. 7, the evidence passage level GUI 700 may comprise a listing of evidence passages from the source. Each entry in the listing may comprise information specific to a particular evidence passage including text from the evidence passage, a particular evidence score associated with the particular evidence passage, or the like.

It should be appreciated that while FIG. 7 illustrates one example of the manner by which evidence passage level information may be output by the mechanisms of the illustrative embodiments, the illustrative embodiments are not limited to such. For example, in other illustrative embodiments, evidence passages may not be presented in isolation from the context of the documents in which they are present. For example, in another illustrative embodiment the full text of the source document may be presented with the evidence passage highlighted or otherwise made to be conspicuous in the display and the source document automatically scrolled to the evidence passage. In this way, the user is given the text surrounding the evidence passage as a context for the evidence passage, such as may be helpful in cases where the evidence passage itself does not provide sufficient information for the particular reader.

Thus, the illustrative embodiments provide mechanisms for graphically representing the confidence associated with candidate answers, categorizations of the confidence associated with the candidate answers, and further providing mechanisms by which a user may drill down into evidence that is either “for” or “against” the candidate answer. The classification of evidence “for” or “against” the candidate answer may be based on corresponding evidence scores and the comparison of such evidence scores against one or more threshold values indicative of whether the evidence is “for” or “against” the candidate answer being an actual correct answer for the input question. Drilling down further into the evidence may produce a listing of document or source level information for one or more documents/sources of information that are classified in the particular “for” or “against” classification. The document or source information may, for each document or source, identify the particular document, publication, authorship, evidence score, a summary or description of the document or source, and/or other information about the piece of evidence. The entry for the document or source may be further selectable by a user within the GUI so as to obtain a more detailed level of information about the particular portions of the document or source that provide the evidence “for” or “against” the candidate answer, such as passages from the document or source, titles, factual statements, or other content of the document or source evaluated for evidence in support of or against the candidate answer.

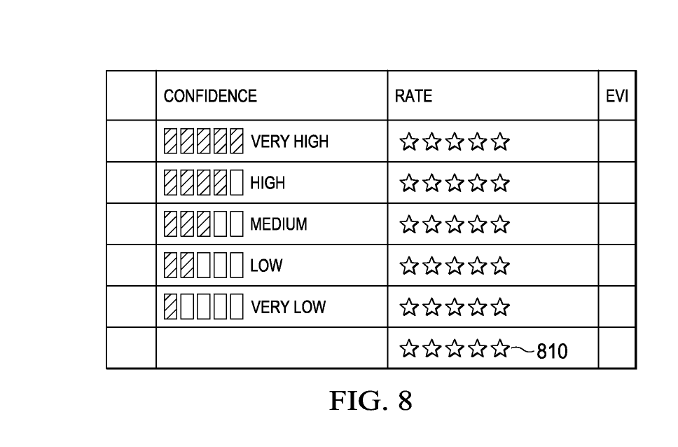

Although not shown in FIG. 5-7, at any or all of the various levels of the graphical user interface, entries for the candidate answers and/or evidence may be associated with a feedback GUI element through which a user may provide feedback as to the correctness of the corresponding entry with regard to the confidence value associated with the candidate answer. FIG. 8 is an example diagram of a portion of a candidate answer level GUI 800 in which user feedback GUI elements are provided for use by a user to provide feedback as to the perceived correctness of the candidate answer's confidence ranking in accordance with one illustrative embodiment. In the depicted example, the GUI elements 810 are provided as a set of 5 star icons in which the user may select any number of these icons to represent the user's perceived correctness of the candidate answer's ranking depicted in the candidate answer level GUI, where 0 stars is representative of the ranking being incorrect and 5 stars being representative of the ranking being absolutely correct, from a user's perspective.

Thus, if the user finds that the candidate answer is correctly categorized as having a high confidence of being a correct answer for the input question, the user may specify a relatively high user feedback value, e.g., 5 stars, indicating that the result generated by the QA system is correct. Similarly, if the user finds that the candidate answer is not correctly categorized as having a high confidence of being a correct answer, then the user can so indicate by providing a relatively low user feedback value, e.g., 1 star. This can be done for all confidence/evidence scores indicating the correctness or inaccuracy of the corresponding confidence/evidence score. Thus, even low confidence/evidence scores may receive user feedback indicating whether or not the low confidence/evidence score is accurate for the particular candidate answer or piece of evidence.

The user feedback may be provided as input to the QA system which may then adjust weightings or other logic applied to the evaluation of candidate answers and evidence so as to adjust the operation of the QA system to be more accurate based on the user feedback. For example, weightings of parameters used during the calculation of confidence scores may be adjusted based on the user feedback. Rankings of sources of information associated with the candidate answer may be adjusted based on the user feedback to indicate whether the source is more or less reliable for generating future candidate answers. Any suitable modification to the way in which sources and evidence passages are evaluated may be performed based on the user feedback provided via the GUI elements 810. As noted above, such GUI elements 810 may be provided at various levels of GUI output, e.g., any of the GUIs depicted in FIGS. 5-7, and thus, the modifications to the way in which the QA system evaluates sources/evidence passages may be different depending upon the particular GUI level information with which the user feedback is provided.

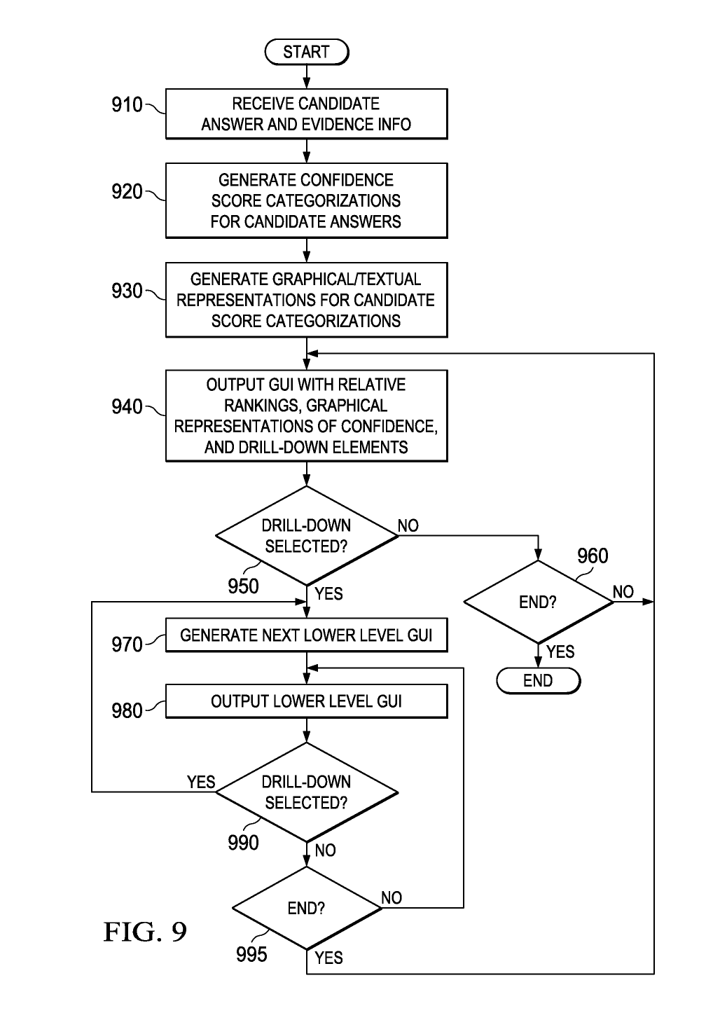

FIG. 9 is a flowchart outlining an example operation for generating a GUI output of candidate answers and corresponding confidence score information in accordance with one illustrative embodiment. As shown in FIG. 9, the operation starts by receiving candidate answer and evidence passage information from a QA system pipeline in response to an input question (step 910). The candidate answer and evidence passage information is processed to generate confidence score categorizations for the various candidate answers (step 920). Corresponding graphical/textual representations for the confidence score and/or confidence score categorizations are generated (step 930) and a graphical user interface listing the relative rankings of the candidate answers is generated comprising the graphical/textual representations of the confidence score and/or confidence score categorizations as well as GUI elements for drilling down into the evidence information (step 940). A determination is made as to whether a user input is received that selects a drill-down GUI element (step 950). If not, the operation determines if an end condition occurs (step 960). The end condition may be any condition that causes the presentation of the GUI to be discontinued, e.g., user input closing the GUI, power-off of the computing device outputting the GUI, or the like.

If the end condition occurs, then the operation terminates. If the end condition does not occur, the operation returns to step 950. If a user input selecting a drill-down GUI element is selected, then a next lower level GUI is generated and output (step 970) and the next lower level GUI is output (step 980). A determination is made as to whether a drill-down element, if any, is selected in the next lower level GUI (step 990). If so, the operation returns to step 970 where another next lower level GUI is generated. If not, the operation determines if the presentation of the lower level GUI is discontinued (step 995). If not, then the operation returns to step 980. Otherwise, if the presentation of the lower level GUI is discontinued, then the operation returns to step 940. Of course, while a single lower level GUI presentation is shown in FIG. 9, it should be appreciated that multiple lower levels of GUI presentation may be used without departing from the spirit and scope of the illustrative embodiments.

As mentioned above, it should be appreciated that while the illustrative embodiments are depicted as utilizing a segmented bar graph representation of confidence score and confidence score categorization, other types of graphical representations may likewise be used. For example, segmented pie chart type representations, various icons for different levels of confidence, solid bar charts, numeric confidence values, speedometer gauge (half circle with needle pointing to the value), and the like, may be used to provide a visual and/or textual output indicative of confidence score values and/or confidence score categorization without departing from the spirit and scope of the illustrative embodiments.

Thus, the illustrative embodiments provide mechanisms for providing a graphical representation of confidence scores for candidate answers in a QA system output. The GUI presenting the graphical representation further provides GUI elements for drilling down into the evidence that supports/detracts from the candidate answer being a correct answer for the input question. Various levels of drilling down are supported by the GUI to allow a user to access various levels of evidence information to gain greater insight into the reasoning behind the candidate answer's corresponding confidence score valuation and categorization.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system comprising a processor and a memory, and being configured to answer an input question, comprising:
receiving, by the data processing system, candidate answer information comprising confidence scores associated with candidate answers for the input question;
categorizing, by the data processing system, for each candidate answer in the candidate answer information, the corresponding confidence score into one of a plurality of confidence score categories;
generating, by the data processing system, for each candidate answer in the candidate answer information, a graphical representation of the confidence score category of the candidate answer; and
generating, by the data processing system, a graphical user interface output comprising an entry for each candidate answer in the candidate answer information, wherein each entry comprises the corresponding graphical representation of the confidence score category of the candidate answer corresponding to the entry.

2. The method of claim 1, wherein the graphical representation of confidence score category of the candidate answer is a segmented bar graph in which segments of the segmented bar graph are configured to represent the confidence score category of the candidate answer.

3. The method of claim 2, wherein the segments of the segmented bar graph are configured at least by outputting a number of segments of the segmented bar graph in accordance with the confidence score category of the candidate answer.

4. The method of claim 2, wherein the segments of the segmented bar graph are configured at least by modifying a color of the segments of the segmented bar graph in accordance with the confidence score category of the candidate answer.

5. The method of claim 2, wherein the segments of the segmented bar graph are configured at least by outputting a number of segments of the segmented bar graph in accordance with the confidence score category of the candidate answer and outputting a color of the segments of the segmented bar graph in accordance with a relative position of the confidence score within a range of confidence scores corresponding to the confidence score category of the candidate answer.

6. The method of claim 1, wherein generating the graphical user interface output comprising an entry for each candidate answer in the candidate answer information, further comprises outputting, for each entry, a textual label in association with the corresponding graphical representation of the confidence score category, wherein the textual label comprises a description of the confidence score category.

7. The method of claim 1, wherein generating the graphical user interface output comprises, for each entry, outputting a user selectable graphical user interface element for receiving an input from a user to drill down into evidence passage information supporting the corresponding confidence score of the entry.

8. The method of claim 7, further comprising:
receiving a user input selecting the graphical user interface element of an entry in the graphical user interface; and
in response to receiving the user input selecting the graphical user interface element, outputting a summary evidence passage information graphical user interface summarizing evidence passage information organized into a first set of evidence passage information that is in support of a candidate answer corresponding to the entry being a correct answer for the input question and a second set of evidence passage information that is not in support of the candidate answer being a correct answer for the input question.

9. The method of claim 8, wherein the summary evidence passage information graphical user interface comprises, for the first set of evidence passage information, a first drill down graphical user interface element that is selectable by a user to drill down into individual evidence passages corresponding to the first set of evidence passage information, and further comprises, for the second set of evidence passage information, a second drill down graphical user interface element that is selectable by the user to drill down into individual evidence passages corresponding to the second set of evidence passage information.

10. The method of claim 1, wherein generating the graphical user interface output comprises, for each entry, outputting a user selectable graphical user interface element for receiving an input from a user indicating a subjective evaluation of correctness of a corresponding confidence score of the entry.

11-20. (canceled)
